(19) United States
(12) Patent Application Publication
(10) Pub. No.: US 2014/0162628 A1
(43) Pub. Date: Jun. 12, 2014

(54) Methods for Validating Radio-Frequency Test Systems Using Statistical Weights

(71) Applicant: APPLE INC., Cupertino, CA (US)

(72) Inventors: Peter Bevelacqua, San Jose, CA (US); Jayesh Nath, Milpitas, CA (US); Robert W. Schlub, Cupertino, CA (US); Mattia Pascolini, Campbell, CA (US)

(73) Assignee: Apple Inc., Cupertino, CA (US)

(21) Appl. No.: 13/708,792

(22) Filed: Dec. 7, 2012

(51) Int. Cl. H04B 17/00

(52) U.S. Cl. CPC H04B 17/00
USPC 455/423

(57) ABSTRACT

A test system may include test stations for testing the radio-frequency performance of wireless electronic devices. A reference test station may perform test measurements on a group of wireless electronic devices under test (DUTs) to select a reference DUT. The reference test station may gather radio-frequency measurements at a number of test frequencies from the group of DUTs. The reference test station may compute statistical data associated with the gathered measurements. The reference test station may compute weight values associated with each test frequency based on the statistical parameters. The reference test station may compute a weighted mean square error value for each DUT based on the weight values and the statistical data. The reference test station may select a DUT having a minimum weighted mean square error value to serve as the reference DUT, which may be used to calibrate test stations in the test system.

### BACKGROUND

This relates generally to electronic devices, and more particularly, to electronic devices having wireless communications circuitry.

Wireless electronic devices such as portable computers and cellular telephones are often provided with wireless communications circuitry. The wireless communications circuitry is tested in a test system to ensure adequate radio-frequency performance. A given wireless electronic device is typically tested using one or more test stations in the test system. To expedite the testing process, many test stations can be used to test the given wireless electronic device (i.e., to determine whether an electric device under test has been manufactured properly or whether an electric device under test satisfies design criteria).

Each test station that is used to test wireless electronic devices typically experiences measurement variation due to variations between individual test stations. The behavior of each test station is typically unique, as it is challenging to manufacture test stations that are exactly identical to one another. Variations among individual test stations make it difficult to provide consistent testing for each device under test.

It would therefore be desirable to be able to provide improved test systems for testing wireless electronic devices

### SUMMARY

A wireless electronic device may include wireless communications circuitry. The wireless communications circuitry may include baseband circuitry, baseband circuitry, and antenna structures. The wireless communications circuitry may transmit and receive radio-frequency signals at a number of different frequencies.

A test system having test equipment may be used to perform radio-frequency testing such as pass-fail testing on a wireless electronic device to determine whether the wireless electronic device has adequate radio-frequency performance. Radio-frequency test signals may be conveyed between the test system and a wireless electronic device under test (DUT) at different frequencies. The test system may include many radio-frequency test stations for testing radio-frequency performance of multiple DUTs. A reference test station in the test system may select a reference DUT from a group of wireless electronic devices under test. The reference DUT may be used to calibrate test stations in the test system.

The test system (e.g., the reference test station in the test system) may gather test data from multiple DUTs by testing the DUTs at desired frequencies. Test data gathered by the test system may include performance metric data associated with the radio-frequency performance of the DUTs. The test system may compute respective statistical parameters such as a respective standard deviation value for test data at each of the desired frequencies. The test system may identify a range of acceptable test data values for test data at each of the desired frequencies. The test system may compute a respective predetermined factor such as a respective weight value for test data at each of the desired frequencies based on the statistical parameters.

For example, weight values may be used to weight test data at each of the desired frequencies. The weight values may depend on the standard deviation value and/or the range of acceptable test data values at each of the desired frequencies. As an example, weight values may be directly proportional to the standard deviation value and/or inversely proportional to the range of acceptable test data values at each of the desired frequencies. The test system may compute a respective mean (average) value for test data at each of the desired frequencies

The test system may use predetermined factors to compute an error value such as a weighted mean square error value for each of the DUTs (e.g., the test system may compute a respective weighted mean square error value for each of the DUTs using weight values and mean values for each of the desired frequencies). The test system may select a reference DUT based on the error value computed for each DUT. For example, the test system may identify a DUT having a minimum weighted mean square error value as the reference DUT. The test system may use the reference DUT to calibrate test stations in the test system (e.g., to ensure that radio-frequency test results are consistent across multiple test stations).

Further features of the present invention, its nature and various advantages will be more apparent from the accompanying drawings and the following detailed description.

### BRIEF DESCRIPTION OF THE DRAWINGS

FIG. 1 is a schematic diagram of an illustrative wireless electronic device having wireless communications circuitry in accordance with an embodiment of the present invention.

FIG. 2 is a diagram of an illustrative test system having multiple test stations for performing radio-frequency testing on wireless electronic devices in accordance with an embodiment of the present invention.

FIG. 3 is diagram of an illustrative master test station that may be used to select reference wireless electronic devices for calibrating test stations of the type shown in FIG. 2 in accordance with an embodiment of the present invention.

FIG. 4 is a flow chart of illustrative steps for calibrating test stations of the type shown in FIG. 2 to ensure consistent radio-frequency testing for wireless electronic devices in accordance with an embodiment of the present invention.

FIG. 5 is an illustrative diagram of radio-frequency measurement values gathered by a master test station from wireless electronic devices at different test frequencies in accordance with an embodiment of the present invention.

FIG. 6 is a flow chart of illustrative steps for computing weighted mean square error values with a master test station to select a reference wireless electronic device in accordance with an embodiment of the present invention.

FIG. 7 is a graph showing how radio-frequency measurement values of the type shown in FIG. 5 may be described by statistical parameters that can be used to compute weighted mean square error values in accordance with an embodiment of the present invention.

### DETAILED DESCRIPTION

This relates generally to wireless communications, and more particularly, to systems and methods for testing wireless communications circuitry.

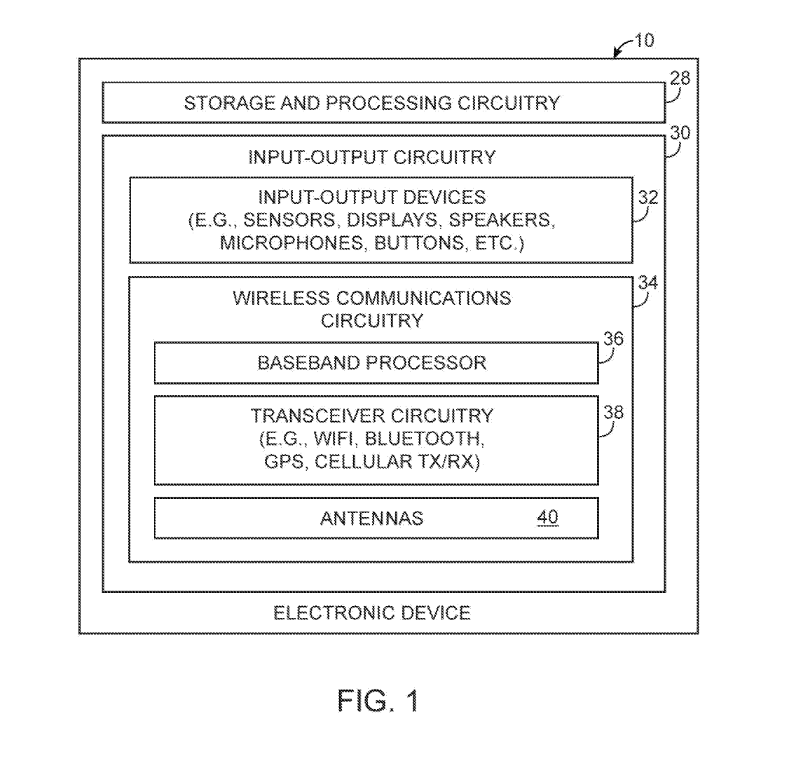

Electronic devices such as device 10 of FIG. 1 may be provided with wireless communications circuitry. The wireless communications circuitry may be used to support long-range wireless communications such as communications in cellular telephone bands. Examples of long-range (cellular telephone) bands that may be handled by device 10 include the 800 MHz band, the 850 MHz band, the 900 MHz band, the 1800 MHz band, the 1900 MHz band, the 2100 MHz band, the 700 MHz band, and other bands. The long-range bands used by device 10 may include the so-called LTE (Long Term Evolution) bands. The LTE bands are numbered (e.g., 1, 2, 3, etc.) and are sometimes referred to as E-UTRA operating bands.

Long-range signals such as signals associated with satellite navigation bands may be received by the wireless communications circuitry of device 10. For example, device 10 may use wireless circuitry to receive signals in the 1575 MHz band associated with Global Positioning System (GPS) communications, in the 1602 MHz band associated with Global Navigation Satellite System (GLONASS) communications, etc. Short-range wireless communications may also be supported by the wireless circuitry of device 10. For example, device 10 may include wireless circuitry for handling local area network links such as WiFi® links at 2.4 GHz and 5 GHz, Bluetooth® links at 2.4 GHz, etc. In general, wireless communications circuitry in device 10 may support wireless communications in any suitable communications bands.

As shown in FIG. 1, device 10 may include storage and processing circuitry 28. Storage and processing circuitry 28 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 28 may be used to control the operation of device 10. This processing circuitry may be based on one or more microprocessors, microcontrollers, digital signal processors, application specific integrated circuits, etc.

Storage and processing circuitry 28 may be used to run software on device 10, such as internet browsing applications, voice-over-internet-protocol (VOIP) telephone call applications, email applications, media playback applications, operating system functions, functions related to communications band selection during radio-frequency transmission and reception operations, etc. To support interactions with external equipment (e.g., a radio-frequency base station, radio-frequency test equipment, etc.), storage and processing circuitry 28 may be used in implementing communications protocols.

Communications protocols that may be implemented using storage and processing circuitry 28 include internet protocols, wireless local area network protocols (e.g., IEEE 802.11 protocols—sometimes referred to as WiFi®), protocols for other short-range wireless communications links such as the Bluetooth® protocol, IEEE 802.16 (WiMax) protocols, cellular telephone protocols such as the “2G” Global System for Mobile Communications (GSM) protocol, the “2G” Code Division Multiple Access (CDMA) protocol, the “3G” Universal Mobile Telecommunications System (UMTS) protocol, the “3G” Evolution-Data Optimized (EV-DO) protocol, the “4G” Long Term Evolution (LTE) protocol, MIMO (multiple input multiple output) protocols, antenna diversity protocols, etc. Wireless communications operations such as communications band selection operations may be controlled using software stored and running on device 10 (i.e., stored and running on storage and processing circuitry 28 and/or input-output circuitry 30).

Input-output circuitry 30 may include input-output devices 32. Input-output devices 32 may be used to allow data to be supplied to device 10 and to allow data to be provided from device 10 to external devices. Input-output devices 32 may include user interface devices, data port devices, and other input-output components. For example, input-output devices may include touch screens, displays without touch sensor capabilities, buttons, joysticks, click wheels, scrolling wheels, touch pads, key pads, keyboards, microphones, cameras, buttons, speakers, status indicators, light sources, audio jacks and other audio port components, digital data port devices, light sensors, motion sensors (accelerometers), capacitance sensors, proximity sensors, etc.

Input-output circuitry 30 may include wireless communications circuitry 34 for communicating wirelessly with external equipment (e.g., a radio-frequency base station, radio-frequency test equipment, etc.). Wireless communications circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless communications circuitry 34 may include radio-frequency transceiver circuitry 38 for handling various radio-frequency communications bands. For example, circuitry 38 may handle the 2.4 GHz and 5 GHz communications bands for WiFi® (IEEE 802.11) communications, the 2.4 GHz communications band for Bluetooth® communications, cellular telephone bands such as at 850 MHz, 900 MHz, 1800 MHz, 1900 MHz, and 2100 MHz and/or the LTE bands and other bands (as examples). Circuitry 38 may handle voice data and non-voice data traffic. Transceiver circuitry 38 may include global positioning system (GPS) receiver equipment for receiving GPS signals at 1575 MHz or for handling other satellite positioning data.

Wireless communications circuitry 34 may include one or more antennas 40. Antennas 40 may be formed using any suitable antenna types. For example, antennas 40 may include antennas with resonating elements that are formed from loop antenna structures, patch antenna structures, inverted-F antenna structures, slot antenna structures, planar inverted-F antenna structures, helical antenna structures, hybrids of these designs, etc. Different types of antennas may be used for different bands and combinations of bands. For example, one type of antenna may be used in forming a WiFi® wireless link antenna and another type of antenna may be used in forming a cellular wireless link antenna. During communication operations, transceiver circuitry 38 may be used to transmit radio-frequency signals at desired frequencies via antennas 40 (e.g., antennas 40 may transmit wireless signals having a desired frequency).

As shown in FIG. 1, wireless communications circuitry 34 may also include baseband processor 36. Baseband processor 36 may include memory and processing circuits and may also be considered to form part of storage and processing circuitry 28 of device 10.

Baseband processor 36 may be used to provide data to storage and processing circuitry 28. Data that is conveyed to circuitry 28 from baseband processor 36 may include raw and processed data. Raw data may, for example, include downlink data received using wireless communications protocols. The processed data passed to circuitry 28 from baseband processor 36 may include data associated with wireless performance metrics for received (downlink) signals (sometimes referred to as performance parameters) such as received power, receiver sensitivity, frame error rate, bit error rate, channel quality measurements based on received signal strength indicator (RSSI) information, adjacent channel leakage ratio (ACLR) information, channel quality measurements based on received signal code power (RSCP) information, channel quality measurements based on reference symbol received power (RSRP) information, channel quality measurements based on signal-to-interference ratio (SINR) and signal-to-noise ratio (SNR) information, channel quality measurements based on signal quality data such as Ec/Io or Ec/No data, information on whether responses (acknowledgements) are being received from a cellular telephone tower corresponding to requests from the electronic device, information on whether a network access procedure has succeeded, information on how many re-transmissions are being requested over a cellular link between the electronic device and a cellular tower, information on whether a loss of signaling message has been received, information on whether paging signals have been successfully received, and other information that is reflective of the performance of wireless circuitry 34. For example, baseband processor 36 may monitor and process raw data to generate radio-frequency performance parameter data.

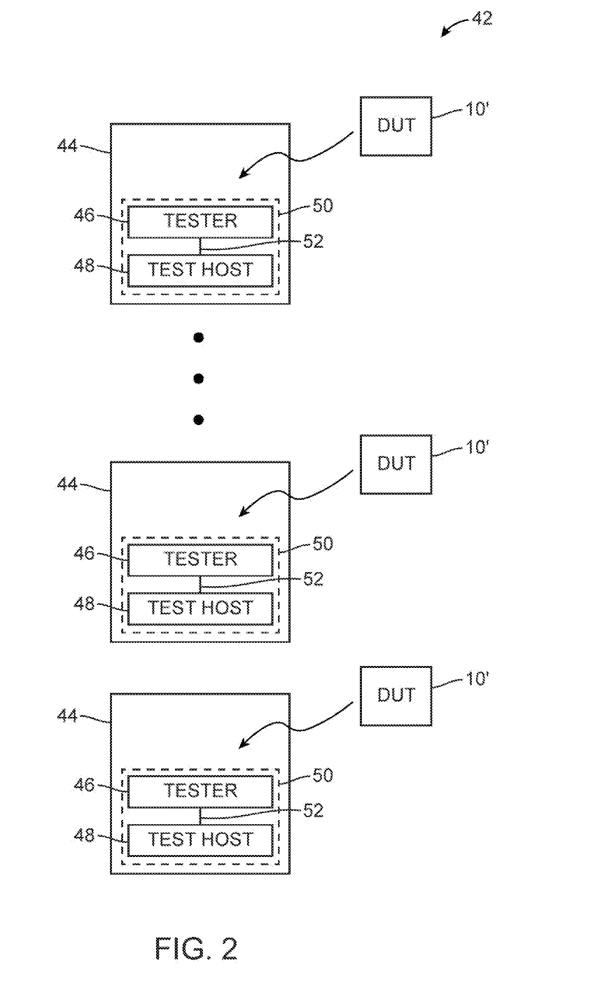

A radio-frequency test station may be provided for performing radio-frequency tests on wireless communications circuitry in electronic devices such as device 10 (e.g., to ensure adequate radio-frequency performance of wireless communications circuitry 34 in device 10). The radio-frequency performance of multiple wireless electronic devices 10 may be tested using a test system such as test system 42 of FIG. 2. As shown in FIG. 2, test system 42 may include a number of radio-frequency test stations 44. Test stations 44 may be used to perform radio-frequency tests on wireless communications circuitry 34 in electronic devices 10.

Each electronic device that is being tested using radio-frequency test stations 44 may sometimes be referred to as device under test (DUT) 10′. DUT 10′ may be, for example, a fully assembled electronic device such as electronic device 10 or a partially assembled electronic device (e.g., DUT 10′ may include some or all of wireless circuitry 34 prior to completion of manufacturing). It may be desirable to test wireless communications circuitry 34 within partially assembled electronic devices so that wireless communications circuitry 34 can be more readily accessed during test operations (e.g., to test the performance of wireless communications circuitry 34 that have not yet been enclosed within a device housing).

Test stations 44 may each include a test host such as test host 48 (e.g., a personal computer, laptop computer, tablet computer, handheld computing device, etc.) and a test unit such as tester 46. Test host 48 and tester 46 may include storage circuitry. Storage circuitry in test host 48 and tester 46 may include one or more different types of storage such as hard drive storage, nonvolatile memory (e.g., flash memory or other electrically-programmable-read-only memory), volatile memory (e.g., static or dynamic random-access-memory), etc.

During test operations, radio-frequency test signals may be transmitted between DUT 10′ and tester 46 in a given test station 44. For example, radio-frequency uplink test signals may be transmitted from DUT 10′ and received by tester 46, whereas radio-frequency downlink test signals may be transmitted from tester 46 and received by DUT 10′. Test signals transmitted between DUT 10′ and test station 44 during testing may be transmitted at selected frequencies (sometimes referred to as test frequencies). For example, tester 46 may provide downlink test signals to DUT 10′ at a first frequency while DUT 10′ provides uplink test signals to tester 46 at the first frequency. As another example, tester 46 may provide downlink test signals to DUT 10′ at a second frequency that is different than the first frequency while DUT 10′ provides uplink test signals to tester 46 at the second frequency. This example is merely illustrative. If desired, DUT 10′ may provide uplink test signals without simultaneously receiving downlink test signals and tester 46 may provide downlink test signals without simultaneously receiving uplink test signals. Test signals transmitted between test stations 44 and DUTs 10′ may be used to characterize the radio-frequency performance of DUTs 10′.

Tester 46 may include, for example, a radio communications analyzer, spectrum analyzer, signal generator, power sensor, vector network analyzer, or any other suitable components for performing radio-frequency test operations on DUT 10′. Tester 46 may be used to characterize uplink and downlink behaviors of DUT 10′. For example, tester 46 may provide (transmit) radio-frequency downlink test signals at desired frequencies to DUT 10′. DUT 10′ may measure performance parameters for downlink signals received from tester 46 (e.g., receiver sensitivity, RSSI, RSRP, SNR, etc.). Performance parameters measured by DUT 10′ for downlink signals received from tester 46 may be used to characterize the downlink behaviors of DUT 10′ (e.g., the radio-frequency performance of DUT 10′ in response to receiving downlink signals may be characterized).

As another example, DUT 10′ may provide (transmit) radio-frequency uplink test signals at desired frequencies to tester 46. Tester 46 may measure performance parameters for the uplink test signals received from DUT 10′ (e.g., output power level, frequency response, gain, linearity, etc.). Performance parameters measured by tester 46 for uplink test signals received from DUT 10′ may be used to characterize the uplink behaviors of DUT 10′ (e.g., the radio-frequency performance of DUT 10′ when transmitting uplink signals may be characterized).

Tester 46 may be operated directly or via computer control (e.g., when tester 46 receives commands from test host 48). When operated directly, a user may control tester 46 by supplying commands directly to tester 46 using a user input interface of tester 46. For example, a user may press buttons in a control panel on tester 46 while viewing information that is displayed on a display in tester 46. In computer controlled configurations, test host 48 (e.g., software running autonomously or semi-autonomously on test host 48) may communicate with tester 46 by sending and receiving control signals and data over path 52. Test host 48 may send control signals instructing tester 46 to transmit radio-frequency downlink test signals to DUT 10′ and/or instructing tester 46 to measure radio-frequency parameters associated with radio-frequency uplink test signals received from DUT 10′. Tester 46 may convey data such as performance parameters associated with radio-frequency uplink signals received from DUT 10′ to test host 48. Test host 48 and tester 46 may collectively be considered as test equipment 50. Test equipment 50 may be a computer, test station, or other suitable system that performs the functions of test host 48 and tester 46 (e.g., the functionality of test host 48 and tester 46 may be implemented on one or more computers, test stations, etc.).

During test operations, DUT 10′ may, if desired, be coupled to test host 48 through a wired connection. DUT 10′ may, for example, be connected to test host 48 using a Universal Serial Bus (USB) cable, a Universal Asynchronous Receiver/Transmitter (UART) cable, or other types of cabling. Test host 48 may send control signals that instruct DUT 10′ to perform desired operations during testing. For example, test host 48 may instruct DUT 10′ to measure performance parameters of radio-frequency downlink test signals received from tester 46. Test host 48 may retrieve measured performance parameters from DUT 10′ (e.g., test host 48 may instruct DUT 10′ to send measured performance parameters to test host 48). As another example, test host 48 may instruct DUT 10′ to transmit radio-frequency uplink test signals to tester 46.

During test operations, DUT 10′ may, if desired, be coupled to tester 46 using a wired connection such as radio-frequency cabling structures, radio-frequency probing structures, or any other suitable coupling structures over which to convey radio-frequency signals between tester 46 and DUT 10′ (e.g., uplink and downlink test signals). If desired, DUT 10′ may be coupled to tester 46 through a wireless (over-the-air) connection. In such arrangements, tester 46 may include wireless structures such as test antennas for communicating with DUT 10′ (e.g., test antennas in tester 46 may be used to send wireless downlink test signals to antenna structures 40 in DUT 10′ and to receive wireless uplink test signals from antenna structures 40 in DUT 10′). Test station 44 may, if desired, include a test enclosure (e.g., a transverse electromagnetic cell, etc.) that is used to provide radio-frequency isolation from the outside environment during over-the-air testing.

Each test station 44 in test system 42 may be used to test the radio-frequency performance of a number of DUTs 10′ simultaneously (e.g., many DUTs 10′ may be tested in parallel). DUTs 10′ may be autonomously provided to test stations 44 (e.g., using automatic loaders, conveyor belt structures, etc.) or may be manually provided to test stations 44 for testing (e.g., by a test station operator). Test stations 44 in test system 42 may each perform the same test operations or different test operations on DUTs 10′ (e.g., test stations 44 may be used to measure any desired combination of uplink and downlink performance parameters associated with DUTs 10′ at any desired test frequencies).

DUTs 10′ that exhibit sufficient radio-frequency performance (e.g., as determined by a test station 44 during radio-frequency test operations) may be labeled as “passing” devices. DUTs 10′ that exhibit unsatisfactory radio-frequency performance may be labeled as “failing” devices. Passing devices may be further assembled, tested, and/or provided to users for normal device operation. Failing devices may be discarded, calibrated, re-tested, reworked, etc.

FIG. 2 is merely illustrative. If desired, test stations 44 in test system 42 may have any suitable test equipment for characterizing the radio-frequency performance of DUTs 10′. Test stations 44 may include any desired test equipment suitable for performing radio-frequency measurements on signals received from DUT 10′ and/or suitable for transmitting radio-frequency signals to DUT 10′. Each test station 44 may perform radio-frequency test operations on any desired number of DUTs 10′. For example, a given test station 44 may perform test operations on one DUT 10′ or multiple DUTs 10′ simultaneously (e.g., two DUTs, three DUTs, etc.).

During testing of DUTs 10′ with test system 42, each test station 44 may experience measurement variation due to variations among individual test stations 44 (e.g., process, voltage, and temperature variations that may affect the operation of each test station 44). The behavior of each test station 44 is typically unique, because it is challenging to manufacture test stations that are exactly identical to one another. For example, the behavior of a first test station 44 may be different from the behavior of a second test station 44 while performing tests on DUTs 10′. Variations between any two test stations 44 make it difficult to provide consistent testing in a test system 42 having multiple test stations. It may therefore be desirable to be able to provide a test standard for ensuring that test results are consistent across multiple test stations 44.

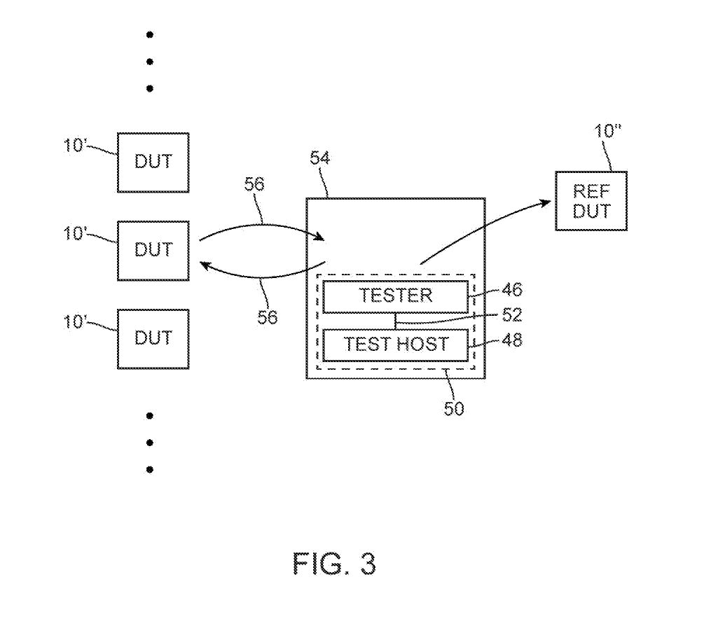

A test standard may be selected from a group of electronic devices under test using a reference test station and may therefore sometimes be referred to as a reference DUT. As shown in FIG. 3, test system 42 may include a “golden” reference test station such as reference test station 54 (sometimes referred to as a “master” test station 54). Master test station 54 may include tester 46 and test host 48 for performing radio-frequency test operations on DUTs 10′. Master test station 54 may, if desired, be selected from test stations 44 in test system 42. Master test station 54 may perform the same radio-frequency test operations on DUTs 10′ as test stations 44 (e.g., radio-frequency test operations for characterizing uplink and downlink behaviors of DUTs 10′ using uplink and downlink test signals). In another suitable arrangement, master test station 54 may be a test station that has been carefully calibrated using a well-known standard. In general, master test station 54 may include any test equipment suitable to perform any desired radio-frequency test operations on DUTs 10′.

In order to select a test standard for ensuring consistent test results across test stations 44, master test station 54 may perform test operations on a group of DUTs 10′. During test operations, each DUT in the group of DUTs 10′ may be individually tested by master test station 54 (see, e.g., arrows 56). Master test station 54 may store performance parameter data (e.g., performance parameters measured by DUT 10′ and tester 46) associated with each DUT 10′ that is being tested. Master test station 54 may process the stored performance parameter data to select a test standard such as reference DUT 10″ from the group of DUTs 10′ tested by master test station 54. Reference DUT 10″ (sometimes referred to as a “golden” DUT or golden reference DUT) may subsequently be used to calibrate individual test stations 44 in test system 42 (e.g., to ensure that test results are consistent across multiple test stations 44).

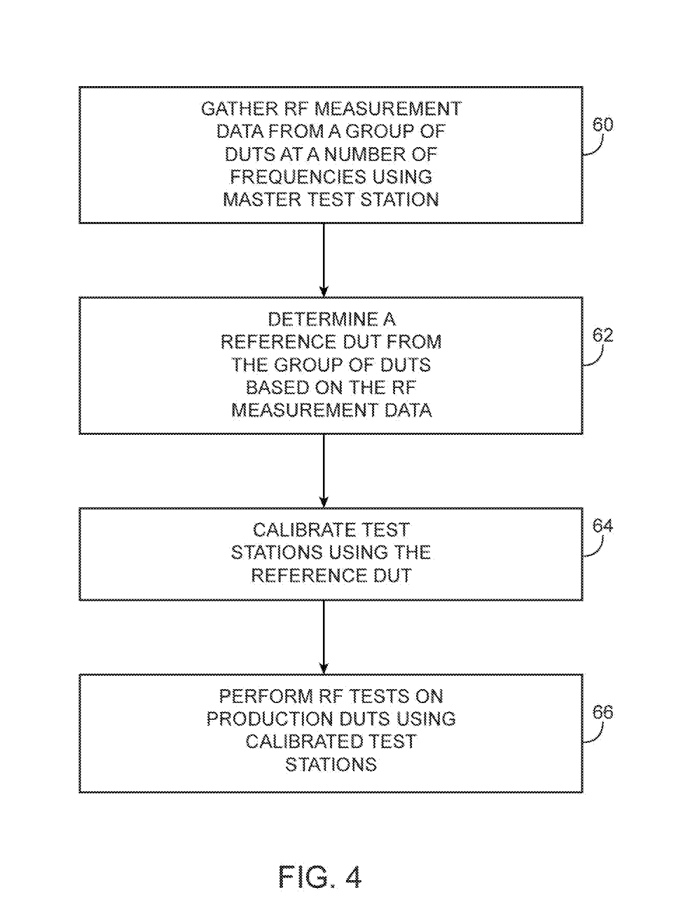

FIG. 4 shows a flow chart of illustrative steps that may be performed by a test system such as test system 42 to test the radio-frequency performance of DUTs 10′. The steps of FIG. 4 may be performed to ensure consistent testing for DUTs 10′ across multiple test stations 44.

At step 60, master test station 54 may gather radio-frequency measurements (e.g., a number of radio-frequency measurement values) from a group of DUTs 10′. Radio-frequency measurement values gathered by master test station 54 may sometimes be referred to as radio-frequency measurement data. Radio-frequency measurement values gathered by master test station 54 may be obtained at a number of different frequencies. Gathered radio-frequency measurement values may be stored in master test station 54 for subsequent analysis.

Master test station 54 may gather radio-frequency measurements from DUTs 10′ by performing wireless communications operations on each DUT 10′. For example, master test station 54 may transmit radio-frequency downlink test signals at different test frequencies to DUT 10′. DUT 10′ may obtain radio-frequency measurement values by performing radio-frequency measurements on received downlink test signals at each test frequency (e.g., each DUT 10′ may obtain a radio-frequency measurement value for each frequency tested). Master test station 54 may subsequently retrieve the radio-frequency measurement values obtained by DUT 10′ (e.g., DUT 10′ may send radio-frequency measurement values to master test station 54). In another suitable arrangement, DUT 10′ may transmit radio-frequency uplink test signals at different frequencies to tester 46. Tester 46 in master test station 54 may gather radio-frequency measurement values by performing radio-frequency measurements on received uplink test signals at each frequency (e.g., tester 46 may obtain a radio-frequency measurement value for each frequency tested).

Radio-frequency measurements gathered by master test station 54 may include performance parameters associated with each DUT 10′. For example, radio-frequency measurement values gathered by master test station 54 may include performance parameters measured by tester 46 for uplink radio-frequency test signals received from DUT 10′ and/or performance parameters measured by DUT 10′ for downlink radio-frequency test signals received from tester 46. Radio-frequency measurement values gathered by master test station 54 may include, for example, receiver sensitivity information, bit error rate information, RSSI information, output power information, or any other desired performance parameter associated with wireless communications operations in DUT 10′. In general, radio-frequency measurement values gathered by master test station 54 may include any desired radio-frequency measurements associated with the transmission or reception of radio-frequency signals by DUT 10′ at a number of different frequencies.

Measurements gathered by master test station 54 from a group of DUTs 10′ may exhibit differences (or “data spread”) due to variations between individual DUTs 10′ (e.g., design variations, manufacturing variations, etc.). The behavior of each DUT 10′ is typically unique, because it is challenging to manufacture devices that are exactly identical to one another. Radio-frequency measurement values gathered by master test station 54 at a given frequency may collectively exhibit a variation (e.g., a first radio-frequency measurement value gathered by master test station 54 in a selected frequency channel may be different from second and third radio-frequency measurement values gathered in the selected frequency channel, etc.).

Variation in radio-frequency measurement values gathered by master test station 54 at each frequency may be characterized by statistical parameters such as a range, average (mean), standard deviation, variance, median, etc. For example, a set of radio-frequency measurement values gathered by master test station 54 from a group of DUTs 10′ at a first frequency may have a first average and a first standard deviation, a set of radio-frequency measurement values gathered by master test station 54 from the group of DUTs 10′ at a second frequency may have a second average and a second standard deviation, etc.

Radio-frequency measurement values gathered by master test station 54 at a given frequency may be subject to a respective limit range specification for the radio-frequency performance of DUT 10′ (sometimes referred to as a limit range). A limit range may be defined as a range of radio-frequency measurement values over which an associated DUT 10′ has acceptable radio-frequency performance. For example, the limit range may provide a range of radio-frequency performance parameter values over which an associated DUT 10′ has acceptable radio-frequency performance (e.g., a range of bit error rates, a range of output powers, etc.). The limit range may have a lower limit and an upper limit (e.g., the limit range may be defined by the difference between the associated upper and lower limits). If master test station 54 obtains a radio-frequency measurement value from a given DUT 10′ that is within the limit range (e.g., if the measurement has a value that is greater than the lower limit and less than the upper limit of the limit range), the associated DUT 10′ may be considered to have satisfactory radio-frequency performance at that frequency. If master test station 54 obtains a radio-frequency measurement value from a given DUT 10′ that is outside of the limit range (e.g., the measurement has a value that is less than the lower limit or greater than the upper limit of the limit range), the associated DUT 10′ may be considered to have unsatisfactory radio-frequency performance at that frequency. For example, a limit range may specify a range of acceptable bit error rates for a group of DUTs 10′. In this scenario, DUTs associated with a bit error rate that is outside of the limit range may have unacceptable radio-frequency performance and DUTs associated with a bit error rate that is within the limit range may have acceptable radio-frequency performance.

A limit range may be specified by carrier-imposed requirements, design requirements, manufacturing requirements, regulatory requirements, or any other suitable requirements associated with the radio-frequency performance of DUT 10′ (e.g., requirements that constrain and/or define acceptable radio-frequency measurement values at a given frequency). Each frequency that is tested (e.g., each frequency at which master test station 54 gathers measurement data values from DUTs 10′) may, if desired, have a respective limit range. For example, a first test frequency may have a first limit range, a second test frequency may have a second limit range, etc. In this way, each frequency may have unique constraints for acceptable radio-frequency measurement values.

At step 62, master test station 54 may process radio-frequency measurement values gathered from DUTs 10′ to select a test standard such as reference DUT 10″. Reference DUT 10″ may be selected from the DUTs 10′ that are measured by master test station 54. Master test station 54 may, for example, compare radio-frequency measurement values gathered from each DUT 10′ at each test frequency to select reference DUT 10″. Master test station 54 may calculate statistical parameters of the radio-frequency measurement values associated with each test frequency to select reference DUT 10″. For example, master test station 54 may select reference DUT 10″ by calculating a value such as a weighted mean square error associated with each measured DUT 10′. If desired, master test station 54 may select a DUT 10′ having a least weighted mean square error to serve as reference DUT 10″. A weighted mean square error associated with each measured DUT 10′ may depend on statistical parameters associated with measurement values gathered by master test station 54. For example, the weighted mean square error associated with each measured DUT 10′ may depend on a standard deviation and an average of radio-frequency measurement values at each test frequency. Reference DUT 10″ may have well-known radio-frequency performance characteristics with which to calibrate test stations 44 in test system 42.

At step 64, reference DUT 10″ is passed to test stations 44 in test system 42. Each test station 44 may perform radio-frequency test measurements on reference DUT 10″. Radio-frequency test measurements performed on reference DUT 10″ by test stations 44 may be used to calibrate each test station 44. For example, each test station 44 may compare radio-frequency test measurements performed on reference DUT 10″ to well-known performance characteristics associated with reference DUT 10″ in order to generate test station offset data.

At step 66, calibrated test stations 44 may perform radio-frequency test operations on DUTs 10′. DUTs 10′ that are tested using test stations 44 after calibration by reference DUT 10″ may sometimes be referred to as production DUTs. Calibrated test stations 44 (e.g., test stations 44 that have been calibrated using reference DUT 10″ during step 64) in test system 42 may provide consistent radio-frequency testing for DUTs 10′.

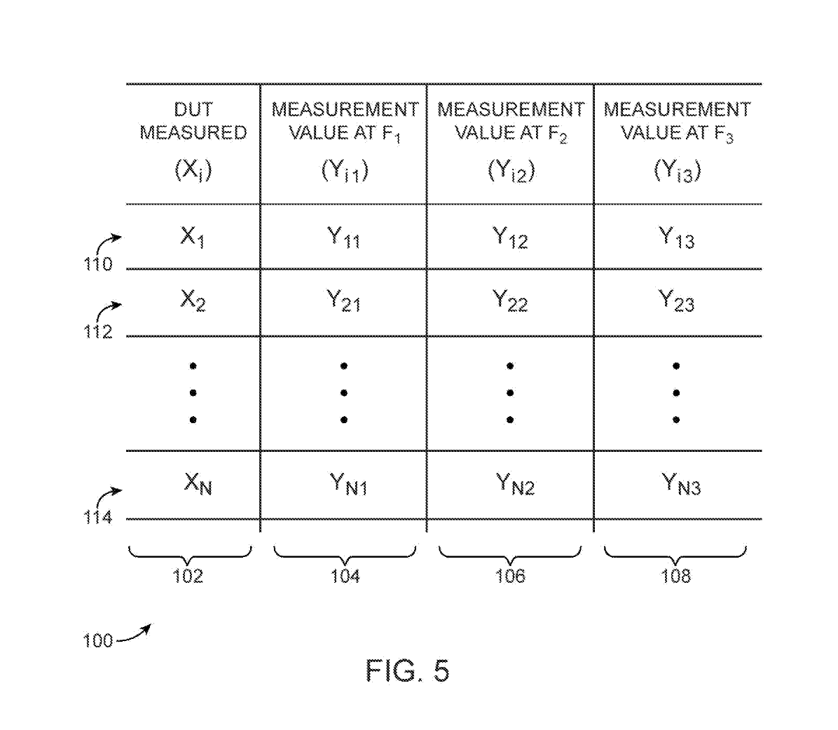

An illustrative table 100 of exemplary radio-frequency measurement values gathered by master test station 54 from a group of DUTs 10′ at different test frequencies is shown in FIG. 5. The radio-frequency measurement values illustrated by FIG. 5 may, for example, be gathered by master test station 54 while performing step 60 of FIG. 4. Table 100 may represent a list of measurement values that are stored in master test station 54. DUTs 10′ that are measured by master test station 54 may be labeled as Xᵢ and may sometimes be referred to herein as DUTs Xᵢ. For example, a first DUT 10′ that is measured by master test station 54 may be labeled X₁ (DUT X₁), a second DUT 10′ may be labeled X₂ (DUT X₂), etc.

In the example of FIG. 5, master test station 54 stores radio-frequency measurement values from a number N of DUTs Xᵢ as shown by column 102 (e.g., measurement values from first DUT X₁, second DUT X₂, etc.). Master test station 54 may store measurement values gathered from DUTs Xᵢ at multiple test frequencies Fⱼ. In the example of FIG. 5, master test station 54 stores measurement values gathered at three frequencies F₁, F₂, and F₃ (e.g., as shown in columns 104, 106, and 108, respectively). Radio-frequency measurement values gathered by master test station 54 may be labeled Yᵢⱼ. Each measurement value (or a set of measurement values) Yᵢⱼ may correspond to a given DUT Xᵢ and a given frequency Fⱼ. For example, as shown by row 110, master test station 54 may store measurement value Y₁₁ gathered from DUT X₁ at frequency F₁, measurement value Y₁₂ gathered from DUT X₁ at frequency F₂, and measurement value Y₁₃ gathered from DUT X₁ at frequency F₃. As shown by row 112, master test station 54 may store measurement value Y₂₁ gathered from DUT X₂ at frequency F₁, measurement value Y₂₂ gathered from DUT X₂ at frequency F₂, and measurement value Y₂₃ gathered from DUT X₂ at frequency F₃. Similar measurement values Yᵢⱼ may be stored by master test station 54 for all DUTs Xᵢ.

If desired, each measurement value Yᵢⱼ may be a performance parameter gathered by master test station 54 such as a performance parameter for uplink test signals received by tester 46 from DUT Xᵢ or a performance parameter for downlink test signals received by DUT Xᵢ from tester 46. As an example, each measurement value Yᵢⱼ may be a receiver sensitivity value measured by DUT Xᵢ in response to downlink test signals received from tester 46 during testing. In this example, measurement value Y₁₁ may be a receiver sensitivity value measured by DUT X₁ in response to downlink test signals transmitted by tester 46 at frequency F₁, measurement value Y₁₂ may be a receiver sensitivity value measured by DUT X₁ in response to downlink test signals transmitted by tester 46 at frequency F₂, etc.

As another example, each measurement value Yᵢⱼ may be an output power value measured by tester 46 in response to uplink test signals received from DUT Xᵢ during testing. In this example, measurement value Y₁₁ may be an output power value measured by tester 46 in response to uplink test signals transmitted by DUT Xᵢ at frequency F₁, measurement value Y₁₂ may be an output power value measured by tester 46 in response to uplink test signals transmitted by DUT X₁ at frequency F₂, etc. In general, each measurement value Yᵢⱼ may be any desired performance parameter gathered by master test station 54.

FIG. 5 is merely illustrative. If desired, master test station 54 may store measurement values Yᵢⱼ gathered from any number of DUTs Xᵢ at any number of test frequencies Fⱼ (e.g., from two DUTs at three frequencies Fⱼ, from four DUTs at ten frequencies Fⱼ, from fifty DUTs at fifty frequencies Fⱼ, etc.). Each test frequency Fⱼ may, if desired, be frequency a channel having a range of associated frequencies.

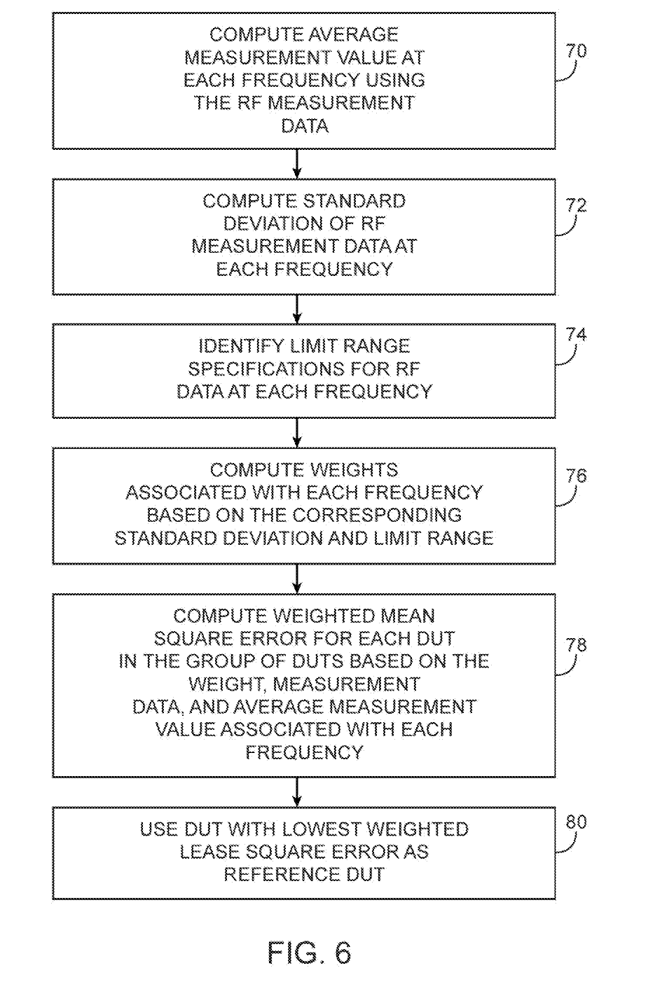

A flow chart of illustrative steps that may be performed by master test station 54 to select a golden test standard such as reference DUT 10″ for calibrating test stations 44 is shown in FIG. 6. The steps of FIG. 6 may, for example, be performed as part of step 62 of FIG. 4. The steps of FIG. 6 may be completed using master test station 54 after gathering and/or storing radio-frequency measurement values for a number of different frequencies such as radio-frequency measurement values Yᵢⱼ shown in table 100 of FIG. 5.

In the example of FIG. 5, master test station 54 stores N measurement values for each test frequency. At step 70, master test station 54 may compute an average value of the radio-frequency measurement values gathered from DUTs Xᵢ at each tested frequency. In this example, master test station 54 computes three average values (e.g., one average value corresponding to each tested frequency Fⱼ). An average value μⱼ of measurement values Yᵢⱼ at a selected frequency Fⱼ (e.g., a frequency such as F₁, F₂, or F₃) may be given by equation 1.

μⱼ=SUM(Yᵢⱼ)/N (1)

In equation 1, SUM(Yᵢⱼ) is a sum of the N measurement values Yᵢⱼ associated with DUTS Xᵢ at a selected frequency Fⱼ. Master test station 54 may compute a respective average value μⱼ for each test frequency Fⱼ. For example, master test station 54 may compute a first average value μ₁ of the N measurement values Yᵢ₁ in column 104 of FIG. 5, may compute a second average value μ₂ of the N measurement values Yᵢ₂ in column 106, etc.

At step 72, master test station 54 may compute a standard deviation value of the radio-frequency measurement values gathered from DUTs Xᵢ at each test frequency. In the example of FIG. 5, master test station 54 may compute three standard deviation values (e.g., one standard deviation value corresponding to each test frequency). Master test station 54 may compute a respective standard deviation value for each tested frequency Fⱼ. For example, master test station 54 may calculate a first standard deviation value of the N measurement values Yᵢ₁ in column 104 of FIG. 5, may compute a second standard deviation value of the N measurement values Yᵢ₂ in column 106, etc. In another suitable arrangement, master test station 54 may compute a variance value of for DUTs Xᵢ at each test frequency.

At step 74, master test station 54 may identify a limit range at each test frequency Fⱼ. The limit range may, if desired, be provided by a test station operator, software implemented by test host 48, etc. Master test station 54 may identify a respective limit range corresponding to each test frequency Fⱼ. For example, master test station 54 may identify a first limit range for the N measurement values Yᵢ₁ in column 104 of FIG. 5, may identify a second limit range for the N measurement values Yᵢ₂ in column 106, etc.

At step 76, master test station 54 may compute a weight value associated with each test frequency Fⱼ. Master test station 54 may calculate each weight value based on the computed standard deviation value and specified limit range for each test frequency Fⱼ. The weight value associated with a selected test frequency may be a quantity that is proportional to the standard deviation value and the limit range associated with the selected test frequency. For example, the weight value may increase as the standard deviation value increases and/or the weight value may decrease as the limit range increases (e.g., the weight value may be directly proportional to the standard deviation value and inversely proportional to the limit range). As an example, a weight value Wⱼ associated with measurement values Yᵢⱼ at a selected test frequency Fⱼ (e.g., at frequency F₁, F₂, or F₃) may be given by equation 2.

Wⱼ=(1+σⱼ/SUM(σⱼ))*(K/ΔLⱼ) (2)

In equation 2, σⱼ is a standard deviation value associated with selected frequency Fⱼ (e.g., a standard deviation value as computed by master test station 54 while performing step 72), SUM(σⱼ) is a sum of all standard deviation values computed for each tested frequency Fⱼ, K is a scaling constant (e.g., any suitable number such as 6, 1.5, etc.), and ΔLⱼ is a limit range specified for selected frequency Fⱼ (e.g., a limit range as specified during processing of step 74).

Each weight value Wⱼ may be used to compute a weighted mean square error associated with each DUT Xᵢ. A weighted mean square error may characterize how well the radio-frequency performance of a given device under test represents the radio-frequency performance of all devices tested by master test station 54 at a given frequency. By computing weight values Wⱼ in this way, a weighted mean square error may include a heavier weighting for measurement values at frequencies corresponding to a large computed standard deviation value (e.g., a large variance in measurement values) than for measurement values at frequencies corresponding to a small standard deviation value. Measurement values in channels having increased measurement variation may, for example, be more significant in determining a weighted mean square error than measurement values in channels having reduced measurement variation. Similarly, a weighted mean square error may include a heavier weighting for measurement values at frequencies having a small limit range than for measurement values at frequencies having a large limit range (e.g., measurement values at frequencies with stricter limit range constraints may be weighted more heavily than measurement values at frequencies with looser limit range constraints). Measurement values in channels with stricter test requirements may, for example, be more significant in determining a weighted mean square error than measurement values in channels with looser test requirements.

At step 78, master test station 54 may compute a weighted mean square error value for each DUT Xᵢ. Master test station 54 may compute each weighted mean square error value based on the calculated weight values, measurement values, and average values associated with each DUT Xᵢ at each frequency Fⱼ. For example, a weighted mean square error value ΔXᵢ for each DUT Xᵢ tested by master test station 54 (i.e., for each of the N DUTs Xᵢ) may be calculated using equation 3.

ΔXᵢ=SUM(Wⱼ²*(Yᵢⱼ−μⱼ)²) (3)

In equation 3, Wⱼ is a weight value computed for test frequency Fⱼ (e.g., a weight value Wⱼ as calculated while processing step 76), Yᵢⱼ is a measurement value gathered from DUT Xᵢ at frequency Fⱼ, μⱼ is an average value of the N measurement values at frequency Fⱼ (e.g., an average value μⱼ as computed while processing step 70), and SUM( ) is a sum over all test frequencies Fⱼ. For example, a weighted mean square error value ΔX₁ corresponding to first measured DUT X₁ (FIG. 5) may be given by equation 4.

ΔX₁=W₁²*(Y₁₁−μ₁)²+W₂²*(Y₁₂−μ₂)²+W₁²*(Y₁₃−μ₃)² (4)

As another example, a weighted mean square error value ΔX_{N} corresponding to an N-th measured DUT X_{N} (see FIG. 5) may be given by equation 5.

ΔX_{N}=W_{N}²*(Y_{N1}−μ₁)²+W_{N}²*(Y_{N2}−μ₂)²+W_{N}²*(Y_{N3}−μ₃)² (5)

At step 80, master test station 54 may identify a minimum (least) weighted mean square error value from calculated mean square error values ΔXᵢ. Master test station 54 may select the DUT Xᵢ associated with the minimum weighted square error value to serve as reference DUT 10″.

For example, master test station 54 may gather measurement values for a first DUT X₁, a second DUT X₂, and a third DUT X₃. First DUT X₁ may have a weighted mean square error value of 0.10, second DUT X₂ may have a weighted mean square error value of 0.22, and third DUT X₃ may have a weighted mean square error value of 0.44. In this scenario, master test station 54 may select first DUT X₁ to serve as reference DUT 10″, because first DUT X₁ has the least weighted mean square value of all DUTs measured by master test station 54. First DUT X₁ may thereby be used to calibrate test stations 44 in test system 42 to ensure consistent testing across test stations 44.

FIG. 6 is merely illustrative. If desired, any suitable weight values may be used in calculating a weighted mean square error for DUTs Xᵢ. For example, weight values Wⱼ may depend on any desired statistical parameters such as a median, range, variance, etc. Any suitable formulation for calculating mean square error based on measured values Yᵢⱼ, weight values Wⱼ, and statistical parameters associated with measurement values gathered from DUTs Xᵢ may be used. Any desired number of measurement values Yᵢⱼ may be gathered from any number of DUTs Xᵢ at any number of test frequencies Fⱼ.

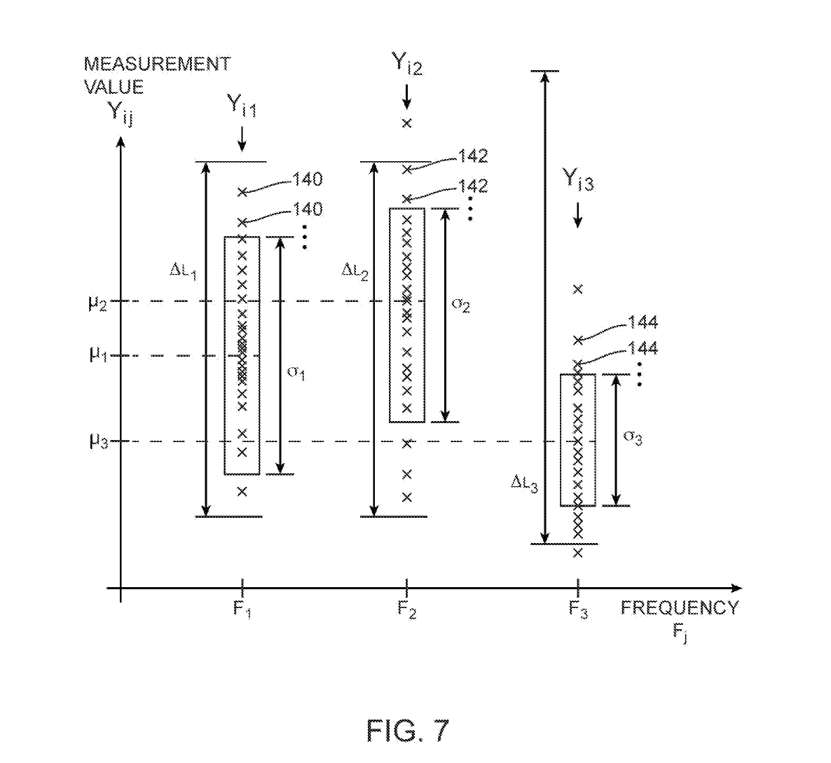

FIG. 7 shows an illustrative graph plotting how measurement values gathered by master test station 54 from a group of DUTs Xᵢ such as measurement values Yᵢⱼ in table 100 of FIG. 5 may vary at different test frequencies. As shown in FIG. 7, data points 140 may correspond to measurement values Yᵢ₁ in column 104 of FIG. 5 (e.g., data points 140 may represent measurement values gathered at frequency F₁), data points 142 may correspond to measurement values Yᵢ₂ in column 106 (e.g., data points 142 may represent measurement values gathered at frequency F₂), and data points 144 may correspond to measurement values Yᵢ₃ in column 108 (e.g., data points 144 may represent measurement values gathered at frequency F₃).

Measurement values 140 may have an average value μ₁ and a standard deviation value σ₁. Measurement values 142 may have an average value μ₂ and a standard deviation value σ₂. Measurement values 144 may have an average value μ₃ and a standard deviation value σ₃. Standard deviation values σ₁, σ₂, and σ₃ may represent the variation (or “spread”) of measurement values at respective test frequencies. Standard deviation values σ₁, σ₂, and σ₃ may represent the variation of measurement values relative to mean values μ₁, μ₂, and μ₃, respectively. A limit range ΔL₁ may be specified for a radio-frequency performance metric associated with measurement values 140, a limit range ΔL₂ may be specified for the radio-frequency performance metric associated with measurement values 142, and a limit range ΔL₃ may be specified for the radio-frequency performance metric associated with measurement values 144. Each mean value, standard deviation value, and limit range shown in FIG. 7 may be calculated by master test station 54 and used to compute a weight value for each frequency Fⱼ and a weighted mean square error value for each DUT Xᵢ (e.g., by processing the steps of FIG. 6).

In the example of FIG. 7, measurement values 144 at frequency F₃ may be weighted less than measurement values 140 and 142 when computing weighted mean square error values because standard deviation value σ₃ is less than standard deviation values σ₁ and σ₂ and limit range ΔL₃ is greater than limit ranges ΔL₁ and ΔL₂ (e.g., weight value W₃ associated with measurement values 144 may be less than weight values W₁ and W₂). In this example, measurement values 144 may be weighted less heavily than measurement values 140 and 142 when computing weighted mean square error values for DUTs 10′ because the requirements for the radio-frequency performance of DUTs 10′ are looser at frequency F₃ than at frequencies F₁ and F₂ (e.g., limit range ΔL₃ imposes less strict requirements on the radio-frequency performance of DUTs 10′ than limit ranges ΔL₁ and ΔL₂). Similarly, measurement values 144 may be weighted less heavily than measurement values 140 and 142 because the variation among measurement values 144 is less than the variation among measurement values 140 and 142 (e.g., standard deviation value σ₃ is associated with a smaller measurement value spread than standard deviation values σ₂ and σ₃).

FIG. 7 is merely illustrative. Measurement values may have any suitable mean value, standard deviation value, and limit range (e.g., as computed by processing the steps of FIG. 6). Any suitable number of measurement values may be gathered from any number of DUTs Xᵢ at any number of test frequencies Fⱼ.

The foregoing is merely illustrative of the principles of this invention and various modifications can be made by those skilled in the art without departing from the scope and spirit of the invention. The foregoing embodiments may be implemented individually or in any combination.

What is claimed is:

1. A method of using a test system, comprising:
with the test system, gathering test data by testing a plurality of electronic devices under test at desired frequencies; and
with the test system, weighting the test data at each of the desired frequencies using a respective predetermined factor.

2. The method defined in claim 1, further comprising:
with the test system, computing a respective standard deviation value for the test data at each of the desired frequencies.

3. The method defined in claim 2, wherein weighting the test data comprises weighting the test data based on the computed standard deviation value at each of the desired frequencies.

4. The method defined in claim 3, wherein the predetermined factor at each of the desired frequencies is directly proportional to the computed standard deviation value at each of the desired frequencies.

5. The method defined in claim 1, further comprising:
with the test system, identifying a respective range of acceptable test data values for the test data at each of the desired frequencies.

6. The method defined in claim 5, wherein weighting the test data comprises:
weighting the test data based on the identified range of acceptable test data values at each of the desired frequencies.

7. The method defined in claim 6, wherein the predetermined factor at each of the desired frequencies is inversely proportional to the identified range of acceptable test data values at each of the desired frequencies.

8. The method defined in claim 5, further comprising:
with the test system, computing a respective standard deviation value for the test data at each of the desired frequencies.

9. The method defined in claim 8, wherein weighting the test data comprises:
weighting the test data based on the computed standard deviation value and identified range of acceptable test data values at each of the desired frequencies.

10. The method defined in claim 8, wherein the predetermined factor at each of the desired frequencies is directly proportional to the computed standard deviation value and inversely proportional to the identified range of acceptable test data values.

11. The method defined in claim 1, wherein the test data comprises performance metric data associated with radio-frequency performance of the electronic devices under test, wherein gathering the test data comprises:
gathering the performance metric data from the plurality of electronic devices under test at the desired frequencies.

12. The method defined in claim 1, further comprising:
with the test system, computing respective statistical parameters for the test data at each of the desired frequencies; and
with the test system, computing the predetermined factors based on the statistical parameters at each of the desired frequencies.

13. The method defined in claim 12, wherein weighting the test data comprises:
using the predetermined factors to compute a weighted mean square error value for each electronic device under test of the plurality of electronic devices under test.

14. The method defined in claim 13, further comprising:
with the test system, computing a respective average value for the test data at each of the desired frequencies, wherein computing the weighted mean square error value comprises computing the weighted mean square error value for each electronic device under test in the plurality of electronic devices under test using the predetermined factors and the computed average values.

15. The method defined in claim 14, further comprising:
identifying an electronic device under test from the plurality electronic devices under test having a minimum computed weighted mean square error value as a reference electronic device under test.

16. A method of using a test system, comprising:
with the test system, gathering test data by testing a plurality of electronic devices under test at desired frequencies;
computing an error value for each of the plurality of electronic devices under test by weighting the gathered data using predetermined factors; and
selecting a reference electronic device under test from the plurality of electronic devices under test based on the computed error value for each of the plurality of electronic devices under test.

17. The method defined in claim 16, wherein the predetermined factors each comprise a respective standard deviation value for the test data at each of the desired frequencies.

18. The method defined in claim 17, wherein computing the error value comprises computing a weighted mean square error value for each of the plurality of electronic devices under test using the standard deviation values at each of the desired frequencies.

19. The method defined in claim 18, wherein selecting the reference electronic device under test comprises identifying an electronic device under test having a minimum computed weighted mean square error value as the reference electronic device under test.

20. The method defined in claim 17, further comprising:
computing a respective mean value for the test data at each of the desired frequencies, wherein computing the error value comprises computing a weighted mean square error value for each of the plurality of electronic devices under test using the standard deviation values and the mean values at each of the desired frequencies.

21. The method defined in claim 19, wherein the test system comprises at least one test station for testing radio-frequency performance of the plurality of electronic devices under test, the method further comprising:
with the reference electronic device under test, calibrating the at least one test station.

22. A test system for testing a plurality of wireless electronic devices, comprising:
test equipment operable to gather radio-frequency test data from the plurality of wireless electronic devices at desired frequencies, wherein:
the test equipment is configured to compute a respective weight value for the test data at each of the desired frequencies;
the test equipment is configured to compute a respective weighted error value for each of the plurality of wireless electronic devices using the computed weight values; and
the test equipment is configured to select a reference wireless electronic device from the plurality of wireless electronic devices based on the weighted error values.

23. The test system defined in claim 22, wherein the test equipment is configured to compute the weight values based on a respective standard deviation value for the test data at each of the desired frequencies.

24. The test system defined in claim 23, wherein the test equipment is configured to compute weight values that are directly proportional to the standard deviation value at each of the desired frequencies.

25. The test system defined in claim 22, wherein the test equipment is configured to compute the weight values based on a respective range of acceptable test data values and a respective standard deviation value for the test data at each of the desired frequencies.

26. The test system defined in claim 25, wherein the test equipment is configured to compute weight values that are directly proportional to the standard value and inversely proportional to the range of acceptable test data values at each of the desired frequencies.

27. The test system defined in claim 22, wherein the test equipment is configured to select a reference wireless electronic device from the plurality of wireless electronic devices having a minimum weighted error value.
